(19) United States
(12) Patent Application Publication
(10) Pub. No.: US 2002/0096264 A1
(43) Pub. Date: Jul. 25, 2002

(54) Label applying unit for a labeling machine and suitable for applying labels of different lengths

(76) Inventor: Sheng-Hui Yang, Taichung City (TW)

Correspondence Address: HARNESS, DICKEY & PIERCE, P.L.C., 5445 Corporate Drive, Troy, MI, 48098, US

(21) Appl. No.: 09/767,781

(22) Filed: Jan. 23, 2001

(51) Int. Cl. B32B 31/00

(52) U.S. Cl. 156/556; 156/64; 156/361

(57) ABSTRACT

A label applying unit for a labeling machine includes a motor-driven guide roller unit which is operable so as to feed one end of a label reel to a label applicator plate. A label sensor is disposed between the label reel and the label applicator plate, and generates first and second signals respectively upon detection of leading and trailing edges of one of the labels of the label reel. An encoder unit is associated with the guide roller unit and is operable so as to generate distance information to indicate distance advanced by the detected label. A controller is coupled electrically to the guide roller unit, the label sensor and the encoder unit, activates the encoder unit upon receipt of the first signal, and obtains length information of the detected label from the encoder unit upon receipt of the second signal. The controller activates the guide roller unit according to the length information and the distance between the label sensor and the label applicator plate so as to dispose the leading edge of the detected label at a proper position relative to a label releasing end of the label applicator plate during a label feeding operation of the guide roller unit.

### BACKGROUND OF THE INVENTION

1. Field of the Invention

The invention relates to a label applying unit for a labeling machine, more particularly to a label applying unit that is suitable for applying labels of different lengths in automated operations.

2. Description of the Related Art

Commodities, such as beverage bottles, drug bottles, containers, and packaging boxes, are generally provided with a label to classify products, to indicate usage and other information, to display the trademark or logo of the manufacturer, etc. With the recent advancement in automation, automated attachment of labels to such commodities has taken the place of manual label attachment, and has become quite popular in the industry.

In a conventional label attaching process, a reel of labels including a backing paper strip and a plurality of labels is arranged on a reel support plate. A leading end of the reel is drawn via a guiding device to a label applicator plate where the labels are applied to containers being advanced by a container conveyer.

Since the sizes of containers vary, the lengths of the labels attached thereto also vary. Although the conventional labeling machine can perform automatic label attachment, since the construction thereof is complicated, it cannot be quickly adjusted to adapt to different lengths of labels. At present, such an adjustment is still performed manually, in combination with alteration of computer control programs according to the label length, and has to be conducted by technicians or engineers since ordinary workers do not possess the required skill for such complicated adjustment.

### SUMMARY OF THE INVENTION

Therefore, the main object of the present invention is to provide a label applying unit for a labeling machine and suitable for applying labels of different lengths so as to overcome the drawbacks associated with the prior art.

Accordingly, a label applying unit of this invention is adapted for use in a labeling machine so as to attach labels onto containers. The label applying unit includes a reel support plate, a label applicator plate, a motor-driven guide roller unit, a label sensor, an encoder unit, and a controller. The reel support plate is adapted to support a label reel, which includes a backing paper strip and a plurality of labels releasably and successively adhered on the backing paper strip, thereon. The label applicator plate is adapted to release the labels from the backing paper strip at a label releasing end thereof. The motor-driven guide roller unit is disposed between the reel support plate and the label applicator plate, and is operable so as to feed one end of the label reel on the reel support plate to the label applicator plate. The label sensor is disposed between the reel support plate and the label applicator plate, and has a sensing plane that is spaced apart from the label releasing end of the label applicator plate by a predetermined distance. The label sensor generates a first signal upon detection of a leading edge of one of the labels on the label reel, and further generates a second signal upon detection of a trailing edge of said one of the labels on the label reel. The encoder unit is associated with the guide roller unit, and is operable so as to generate distance information to indicate distance advanced by said one end of the label reel during operation of the guide roller unit. The controller is coupled electrically to the guide roller unit, the label sensor and the encoder unit. The controller activates the encoder unit upon receipt of the first signal from the label sensor, and obtains length information of said one of the labels on the label reel from the encoder unit upon receipt of the second signal from the label sensor. The controller activates the guide roller unit according to the length information from the encoder unit and the predetermined distance between the sensing plane and the label releasing end so as to dispose the leading edge of said one of the labels at a proper position relative to the label releasing end of the label applicator plate during a label feeding operation of the guide roller unit for feeding said one of the labels to the label applicator plate.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a labeling machine that incorporates the preferred embodiment of a label applying unit according to the invention;

FIG. 2 is a perspective view of the preferred embodiment;

FIG. 3 is a schematic top view of the preferred embodiment;

FIG. 4 is a schematic block diagram of the preferred embodiment;

FIG. 5 is a flow chart illustrating operation of the preferred embodiment; and

FIG. 6 is a schematic view illustrating calculation of length of labels according to the present invention.

### DETAILED DESCRIPTION OF THE PREFERRED EMBODIMENT

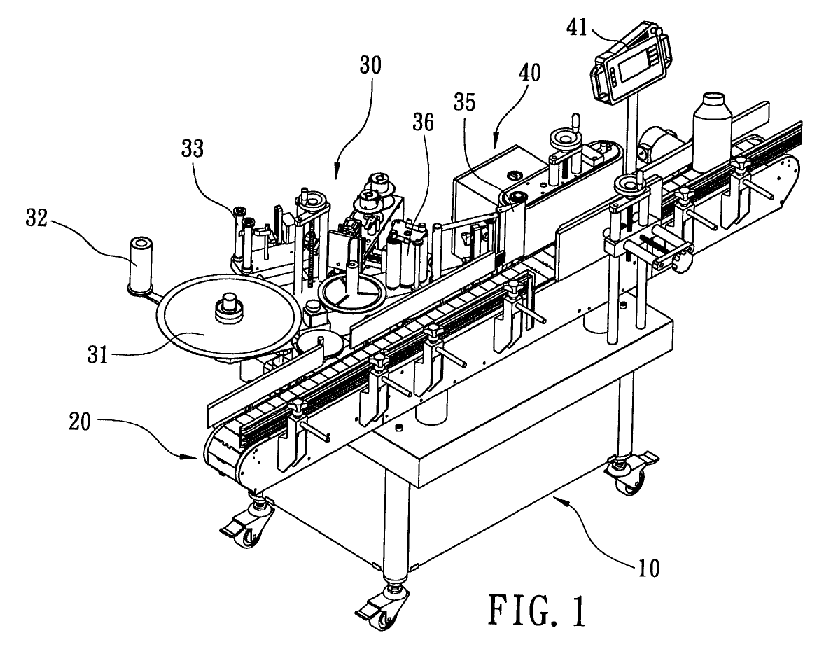

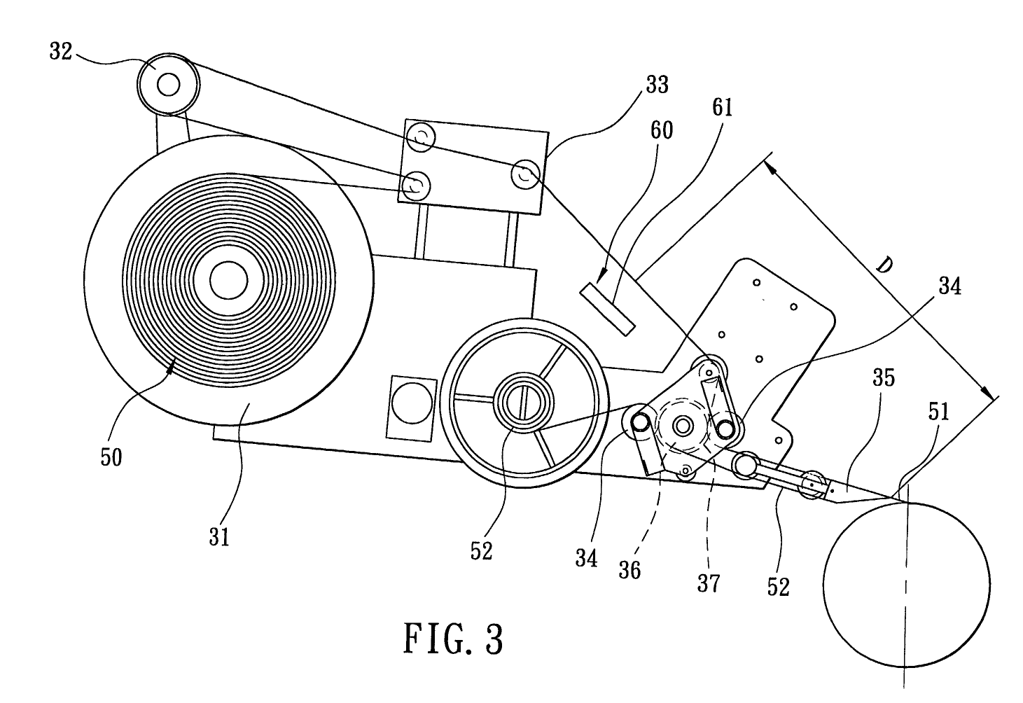

Referring to FIGS. 1 to 3, the preferred embodiment of a label applying unit 30 according to the present invention is adapted for use in a labeling machine 10 so as to attach labels 51 to containers. The labeling machine 10 includes a conveyer unit 20 adapted to convey the containers. As the conveyer unit 20 is known in the art, and since the invention is not characterized by the particular configuration of the conveyer unit 20, a detailed description thereof will not be provided herein for the sake of brevity. The label applying unit 30 includes a reel support plate 31, a label applicator plate 35, a motor-driven guide roller unit, a label sensor 60, an encoder unit 371, and a controller 40.

The reel support plate 31 is adapted to support a label reel 50 thereon. The label reel 50 includes a backing paper strip 52 and a plurality of labels 51 that are releasably and successively adhered on the backing paper strip 52, and that are spaced apart from each other by a predetermined clearance.

The label applicator plate 35 is adapted to release the labels 51 from the backing paper strip 52 at a label releasing end 351 thereof in a conventional manner.

The motor-driven guide roller unit is disposed between the reel support plate 31 and the label applicator plate 35, and is operable so as to feed one end of the label reel 50 on the reel support plate 31 to the label applicator plate 35. The guide roller unit includes a tensioning rod 32, a plurality of guide rollers 33, a plurality of press rollers 34, a drive member 36 disposed between the reel support plate 31 and the label applicator plate 35, and a servo motor (or a step motor) 37 for driving the drive member 36.

The label sensor 60 is disposed between the reel support plate 31 and the label applicator plate 35. The label sensor 60 has a sensing plane 61 that is spaced apart from the label releasing end 351 of the label applicator plate 35 by a predetermined distance (D). The label sensor 60 generates a first signal (A) for transmission to the controller 40 upon detection of a leading edge of one of the labels 51 on the label reel 50, and further generates a second signal (B) for transmission to the controller 40 upon detection of a trailing edge of said one of the labels 51 on the label reel 50. In practice, the leading edge of said one of the labels 51 is found at the clearance between said one of the labels 51 and a preceding one of the labels 51, whereas the trailing edge of said one of the labels 51 is found at the clearance between said one of the labels 51 and a following one of the labels 51. The encoder unit 371 is associated with the servo motor 37 of the guide roller unit and is operable so as to generate distance information to indicate distance advanced by said one end of the label reel 50 via calculation of the rotational cycle of the servo motor 37 during operation of the guide roller unit.

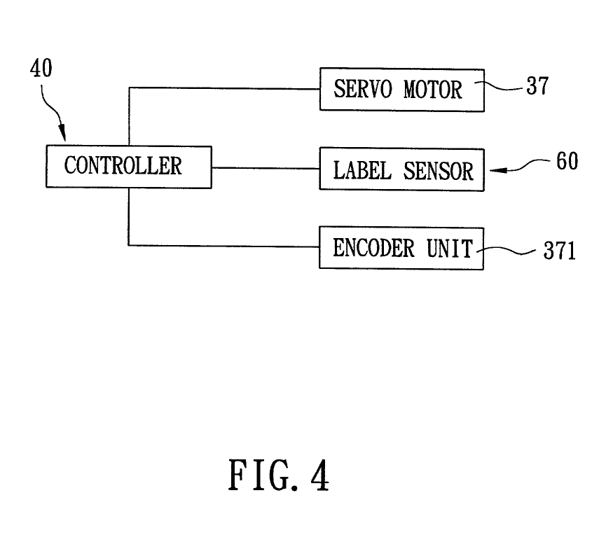

With further reference to FIG. 4, the controller 40 is coupled electrically to the servo motor 37 of the guide roller unit, the label sensor 60 and the encoder unit 371. The controller 40 activates the encoder unit 371 upon receipt of the first signal (A) from the label sensor 60, and obtains length information of said one of the labels 51 on the label reel 50 from the encoder unit 371 upon receipt of the second signal (B) from the label sensor 60. The controller 40 activates the servo motor 37 of the guide roller unit according to the length information from the encoder unit 371 and the predetermined distance (D) between the sensing plane 61 and the label releasing end 351 so as to dispose the leading edge of said one of the labels 51 at a proper position 511 relative to the label releasing end 351 during a label feeding operation of the guide roller unit for feeding said one of the labels 51 to the label applicator plate 35. The leading edge of said one of the labels 51 is peeled from the backing paper strip 52 and projects beyond the label releasing end 351 by a predetermined offset distance when the leading edge of said one of the labels 51 is disposed at the proper position 511 relative to the label releasing end 351.

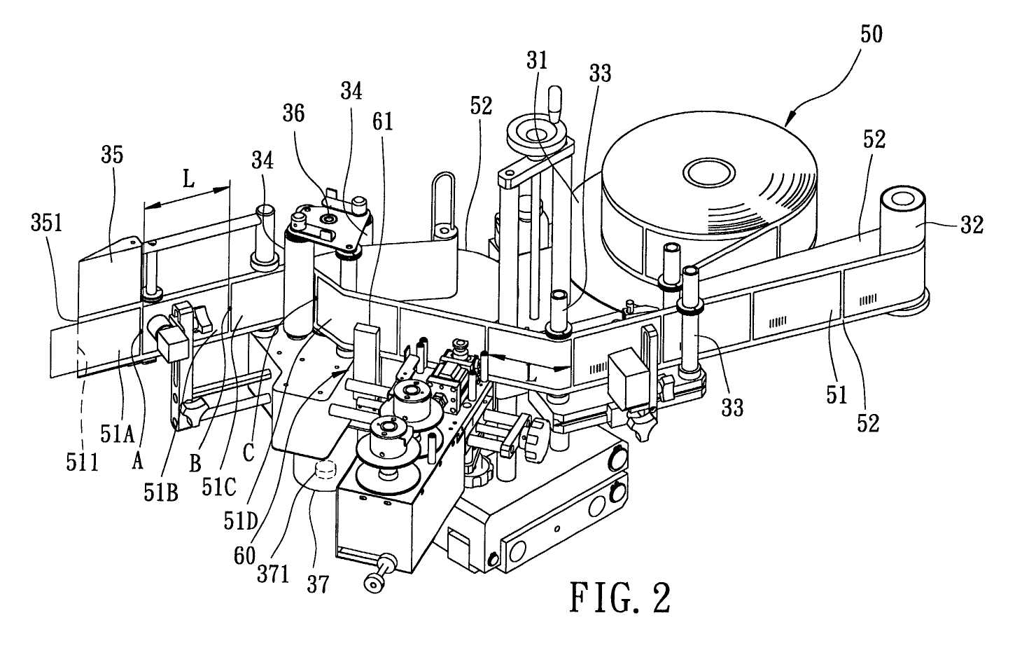

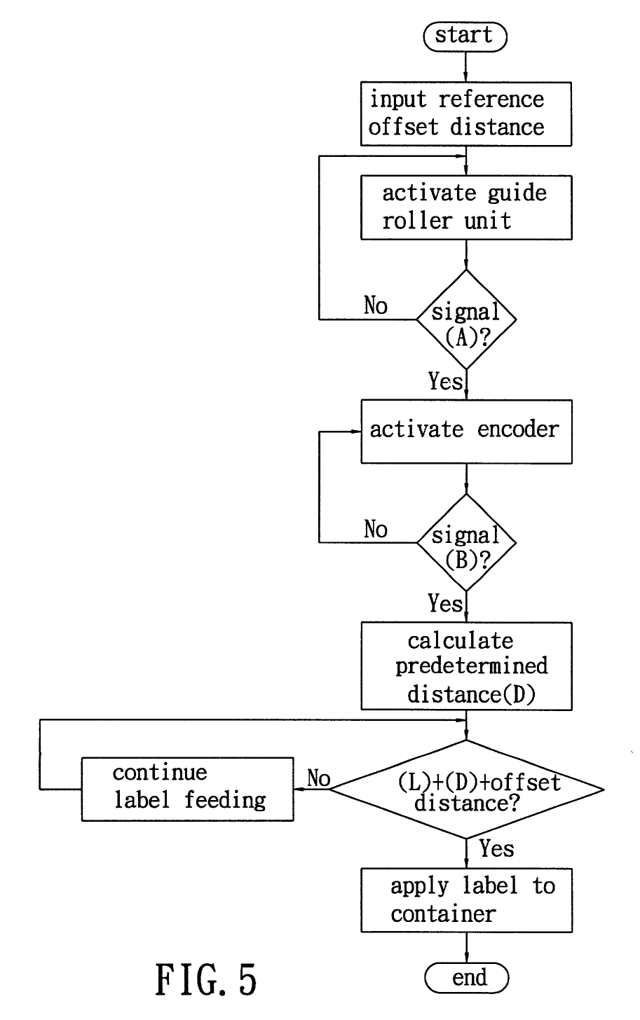

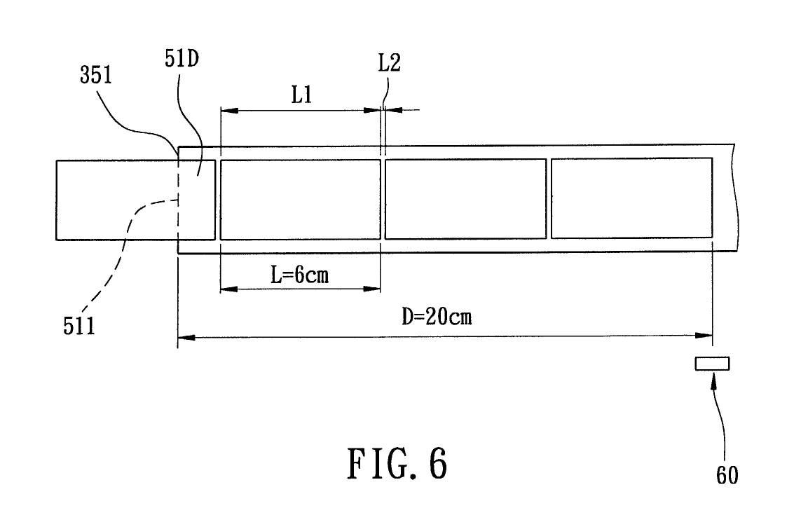

The operation of the label applying unit 30 will now be described with reference to FIGS. 2 to 6. Firstly, it is noted that the predetermined distance (D) between the sensing plane 61 of the label sensor 60 and the label releasing end 351 of the label applicator plate 35 is calculated in digital signals, and can be fixed through proper settings.

When the labeling machine 10 is actuated via a control panel 41 of the controller 40, the servo motor 37 is actuated to rotate the drive member 36 so as to pull one end of the label reel 50 supported on the reel support plate 31 for feeding the labels 51 to the label applicator plate 35 via the guide roller unit. When the label sensor 60 detects the leading edge of a label 51B, which is found at the clearance between labels 51A and 51B, a first signal (A) is generated for transmission to the controller 40 to activate the encoder unit 371, which initiates a counting action. When the trailing edge of the label 51B, which is found at the clearance between the labels 51B and 51C, a second signal (B) is generated and sent to the controller 40. The controller 40 stops the counting action at this

The controller 40 obtains length information (L) of the label 51B via the output of the encoder unit 371 based upon the two signals (A), (B) . In practice, the length information (L) is the sum of a length (L1) of the label 51B itself and the length (L2) of the backing paper 52 between two adjacent ones of the labels 51, in this case, between labels 51B and 51C. According to the length information (L) obtained from the encoder unit 371 and the predetermined distance (D) between the sensing plane 61 and the label releasing end 351, a proper position 511 is determined for disposition of the leading edge of the label 51B relative to the label releasing end 351 such that the leading edge of the label 51B peeled from the backing paper strip 52 projects beyond the label releasing end 351 by a predetermined offset distance. It is noted that in actual practice, the predetermined distance (D) and the length information (L) are calculated in digital signals, as mentioned above, but are herein expressed in centimeters for the sake of easy understanding of the operation of the present invention.

Suppose a reference offset distance of a first one of the labels 51 inputted via the control panel 41 is 0.2 cm, the predetermined distance (D) is 20 cm, and the length of a label 51D to be fed is calculated to be 6 cm. Under the condition that the length (L) of the labels 51 is known, when the label sensor 60 detects the leading edge of the label 51D, i.e., the length of the backing paper strip 52 exposed between the labels 51C and 51D, a signal (C) is generated and sent to the controller 40. The controller 40 will then activate the encoder unit 371 to start calculating the distance advanced by the label 51D, and to determine the time when the leading edge of the label 51D will have covered the predetermined distance of 20 cm. In other words, when the label sensor 60 detects the leading edge of the label 51D, the encoder unit 371 is activated to start calculation until the leading edge of the label 61D reaches the label releasing end 351 of the label applicator plate 35, which means that the label 51D has been advanced by the predetermined distance (D). At this point, by further advancing the leading edge of the label 51D by the predetermined offset distance of 0.2 cm, the leading edge of the label 51D is halted at the proper position 511 for peeling from the backing paper strip 52. As such, the predetermined offset distance, and thus the proper position 511, can be altered through the control panel 41.

It can be appreciated from the aforesaid that this invention can determine the length of a label 51 based upon two signals only, and can determine the proper position 511 of the label 51 to be fed according to the length of the label 51 and the predetermined distance (D) between the sensing plane 61 and the label releasing end 351 of the label applicator plate 35 such that advancement of the label 51 can be halted via operation of the controller 40 during a label feeding operation. By virtue of the construction of the label applying unit 30, advancement of labels 51 can be controlled to a proper position 511 that can be calculated in a fully automated operation for labels of different lengths so as to ensure the precise attachment of labels to containers and to enhance efficiency.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A label applying unit adapted for use in a labeling machine so as to attach labels to containers, said label applying unit comprising:
a reel support plate adapted to support a label reel thereon, the label reel including a backing paper strip and a plurality of labels releasably and successively adhered on the backing paper strip;
a label applicator plate adapted to release the labels from the backing paper strip at a label releasing end thereof;
a motor-driven guide roller unit disposed between said reel support plate and said label applicator plate and operable so as to feed one end of the label reel on said reel support plate to said label applicator plate;
a label sensor disposed between said reel support plate and said label applicator plate, said label sensor having a sensing plane that is spaced apart from said label releasing end of said label applicator plate by a predetermined distance, said label sensor generating a first signal upon detection of a leading edge of one of the labels on the label reel and further generating a second signal upon detection of a trailing edge of said one of the labels on the label reel;
an encoder unit associated with said guide roller unit and operable so as to generate distance information to indicate distance advanced by said one end of the label reel during operation of said guide roller unit; and
a controller coupled electrically to said guide roller unit, said label sensor and said encoder unit, said controller activating said encoder unit upon receipt of the first signal from said label sensor and obtaining length information of said one of the labels on the label reel from said encoder unit upon receipt of the second signal from said label sensor, said controller activating said guide roller unit according to the length information from said encoder unit and the predetermined distance between said sensing plane and said label releasing end so as to dispose the leading edge of said one of the labels at a proper position relative to said label releasing end of said label applicator plate during a label feeding operation of said guide roller unit for feeding said one of the labels to said label applicator plate.

2. The label applying unit of claim 1, wherein the leading edge of said one of the labels is peeled from the backing paper strip and projects beyond said label releasing end of said label applicator plate by a predetermined offset distance when the leading edge of said one of the labels is disposed at the proper position relative to said label releasing end.
